(19) United States
(12) Patent Application Publication
(10) Pub. No.: US 2001/0037275 A1
(43) Pub. Date: Nov. 1, 2001

(54) System and method for giving appreciated assets

(75) Inventors: Donald Edward Johnson, Belmont, MA (US); Duane Allen Steward, Orlando, FL (US)

Correspondence Address: Mary Lou Wakimura, Esq., HAMILTON, BROOK, SMITH & REYNOLDS, P.C., Two Militia Drive, Lexington, MA, 02421-4799, US

(73) Assignee: AssetStream Corp., Woburn, MA (US)

(21) Appl. No.: 09/767,031

(22) Filed: Jan. 22, 2001

Related U.S. Application Data
(60) Provisional application No. 60/177,722, filed on Jan. 21, 2000.

(51) Int. Cl. G06F 17/60

(52) U.S. Cl. 705/36

(57) ABSTRACT

Giving appreciated assets is accomplished by analysis and processing for tax-advantaged asset transfer to charity. Easy access to sophisticated evaluation tools for choosing gifts that maximize tax-efficient giving; fully automated transfer mechanism for giving appreciated assets on a continuing basis (e.g., monthly or quarterly); speed of transfer; “point, click and give” ease of transferring assets to charity; removal of wealth barriers in the area of asset gifting; back-office support for the transfer of assets to charities and donor advised organizations; and an ability to gift unrealized gains (while keeping 100% of the basis) through currently existing hedge funds is provided.

### RELATED APPLICATION(S)

This application claims the benefit of U.S. Provisional Application No. 60/177,722, filed Jan. 21, 2000. The entire teachings of the above application(s) are incorporated herein by reference.

### BACKGROUND OF THE INVENTION

Considering that individuals gave $135 billion in 1998 to charity, $100 billion of which was contributed in the form of cash, a tremendous potential exists for donors to become more tax efficient in their giving patterns. Congress has intentionally left a tax “loophole” available for donors for the purpose of stimulating greater charitable giving, and yet very few donors are taking advantage of this potential tax deduction. With only 3% of Americans currently taking partial (but certainly not full) advantage of giving appreciated assets, there exists the possibility that many times that number could be giving assets rather than cash.

In 1998 American charities received $174.5 billion in contributions. Of this amount, over 75%, or $134.8 billion, was contributed by individual donors. Buoyed by a strong economy and continuing gains in the stock market, individual donors have increased their giving to charitable causes by more than 40% in just the last three years, an average growth rate of 12% per year. Growth in charitable giving has been even stronger since 1990, increasing at an annual rate of almost 14%. If individual donors' giving continues to grow at even two thirds this rate over the coming decade charitable giving by individuals could more than double. Approximately three out of every four dollars given to charity each year are given in the form of cash. Even though nine out of every 10 Americans contribute to charity each year, only 3% of the American public have ever contributed via appreciated assets. Given that almost three quarters of all Americans now participate in the stock market, this represents a huge inefficiency in the way people are choosing to give to their favorite charities. Even the wealthy, while doing better than average in terms of giving efficiency, are far from optimizing their charitable giving. Those with incomes in excess of $1 million still give 44% of their annual contributions in the form of cash rather than appreciated assets. Studies of the asset allocations for such high net-worth individuals suggest that they should typically be able to make over 90% of their gifts in the form of appreciated assets.

Exact estimates of the total number of households which could be making part or all of their charitable giving in the form of appreciated assets are elusive. However, an examination of IRS individual tax return information suggests that an estimated 27 million households own stock or mutual funds in taxable accounts.

TABLE 1

| | | | | Total |
|---|---|---|---|---|
| | | | Average | Do- |
| | | Average | Donation | nations |
| Adjusted Gross | Number of | Investment | per | (Bil- |
| Income Brackets | Households | Assets | Household | lions) |
| $25,000-$49,999 | 30,149,985 | 66,910 | 675 | 20.4 |
| $50,000-$74,999 | 14,322,850 | 118,070 | 1,322 | 18.9 |
| $75,000-$99,999 | 5,801,418 | 215,440 | 1,986 | 11.5 |
| $100,000-$199,999 | 4,612,554 | 523,440 | 2,963 | 13.7 |
| $200,000-$499,999 | 1,198,671 | 1,687,780 | 6,874 | 8.2 |
| $500,000-$999,999 | 213,823 | 4,660,660 | 18,145 | 3.9 |
| >$1,000,000 | 110,912 | 21,168,740 | 119,830 | 13.3 |

Table 1, reporting the levels of giving for American households with adjusted gross incomes greater than $25,000, shows that many Americans have the potential to make part or all of their charitable gifts in the form of appreciated assets. Even those households with adjusted gross incomes between $25,000 and $50,000 have investment assets (not including personal residences or retirement plan assets) which might be used for charitable giving—$67,000 on average.

Because of the currently practiced cumbersome procedure involved in gifting assets, almost no donors who are giving $1,000-$3,000 per year to charity make gifts of appreciated assets, even though Table 1 suggests that many of these individuals have assets they could be giving. More broadly, most donors giving between $1,000 and $10,000 per year to charity give cash rather than assets. A Donor Advised Fund (“DAO”), like Fidelity's Charitable Gift Fund, targets only donors giving over $10,000 per year. However, Table 1 show that there are some 26 million households currently giving in the $1,000-$10,000 range, representing an estimated $52 billion in gifts to charity each year.

Although only a small fraction of individuals who could be giving to charity via appreciated assets are currently doing so, this form of giving is being heavily promoted. The first and perhaps clearest evidence of this is a review of the literature most charities send to their donors. The great majority of these charities make the effort to point out to their donors that the charity is able to receive appreciated assets in lieu of cash. While the charities are doing a good job alerting donors to the possibility of this type of gift (and in some cases also explaining the benefits of asset giving), they fall short of providing easy instructions for the donors. The most common means of providing further instructions is to require the donor to call a representative at the charity.

Donor Advised Organizations (DAOs) provide the next level of service for the charitably inclined by seeking to offer a little more assistance than the typical charity can afford to provide. These DAOs, often called Community Foundations, require higher minimum contributions, but for more generous donors, the DAOs are a good solution for giving appreciated assets. The donor may make one large contribution in the form of appreciated assets to the DAO, which the DAO would then sell. The donor would then request that the DAO send “grants” to the donor's favorite charities from the proceeds of this sale.

The use of DAOs is quickly catching on as a more convenient means of tax-efficient charitable giving. It is in fact the fastest growing sector of philanthropic giving today. The number of Community Foundations (or DAOs) in the U.S. has more than doubled in the last decade, with much of this growth having come within the past few years. Total assets of the more than 550 DAOs now in existence reached approximately $21 billion and receive contributions from individual donors well in excess of $2 billion annually. Ten years ago there were 250 Community Foundations with total assets of about $6 billion.

An exemplary DAOs is the Fidelity Investment Charitable Gift Fund. Since its inception in 1992, it has grown to become by far the largest DAO in America, so large in fact that it is ranked third in size of all charitable organizations in terms of annual contributions. In 1998 the fund received $572 million in contributions. It currently has 18,000 donors, $1.7 billion in assets, and has granted more than $1 billion to 50,000 nonprofit organizations across the country since it began. Recognizing the tremendous profit potential in assisting donors in their charitable giving, Fidelity has begun a major nationwide advertising campaign to draw in additional donors.

This aggressive push by Fidelity to capture the charitable giving market for appreciated assets, coupled with both the rise in total Community Foundations and the marketing push by individual charities all lead to one conclusion: the giving of appreciated assets is quickly becoming a popular means of contributing to charity.

Given the obvious benefits to both donor and beneficiary when contributing appreciated assets, the crucial question arises: why do so many individuals take little or no advantage of this attractive means of giving to their favorite charities? There are several probable reasons, including:

1. Inconvenience in giving assets versus cash;

2. Lack of understanding of the transfer process;

3. Lack of understanding of the substantial tax savings involved, even at smaller levels of giving (under $10,000 per year);

4. No motivation to change the habit of writing checks versus selecting assets for gifting; and

5. Perception that giving assets is only for the wealthy or for those who are older.

While all the above factors likely play a part in deterring donors from participating in the gifting of assets versus cash, the most dominant deterrent is the inconvenience in giving assets versus cash number. Experience with potential donors suggests that many people believe the learning curve required to begin giving appreciated securities is too great relative to the benefit to themselves or to their charity. Similarly, many appear to view the process as too cumbersome to be bothered with, except when giving larger amounts (e.g., more than $10,000 per year to a single charity).

People's perceptions of the current environment are accurate; giving assets rather than cash is too inconvenient and too difficult for them to implement. Relative to the great convenience of writing a check, and the fact that no learning curve is involved, giving stocks is more difficult. Take for example the situation where an individual has decided to begin immediately making 100% of his contributions in the form of appreciated securities rather than cash. Assuming he gives to more than one charity (e.g., the typical Christian may give to his church plus two to four additional charities each year), he would need to do the following steps as outlined in FIG. 1:

1. Donor 100 opens an account with a donor-advised 501(c)(3) organization (DAO) 104 to use as a pass-through agent for assets to donate. In this way assets can be given to only one organization, and that organization can send checks to the desired charities (106, 108). This eliminates the need for making multiple gifts of assets to all of the charities (106, 108), and allows use of assets as gifts even for organizations a donor supports at lower levels.

2. Donor 100 analyzes his portfolio from donor's brokerage account 102 to determine the most tax-efficient gift to be made. Generally this would be the asset that has the greatest long-term gain, though in fact such an asset is not always the best choice as a gift. For mutual fund purchases, this could mean evaluating several dozen separate purchases if he is dollar-cost averaging his investment each month, or if he has invested in the same fund over a few years. Select assets to donate via the DAO 104.

3. Donor 100 contacts the DAO 104 to make it aware that he will be transferring an asset to it in the near future. This will usually involve filling out a form the organization supplies.

4. Donor 100 writes a letter to his broker making the request that the brokerage firm transfer his asset(s) to the DAO 104. The letter to the brokerage/investment firm may have to be notarized or guaranteed (some firms require this while others do not).

5. The assets are transferred from the donor's brokerage account 102, via Depository Trust Company transfer, to the DAO 104.

6. The donor 100 is issued a tax receipt from DAO 104 reflecting the asset transfer.

7. Donor 100 contacts the DAO 104 a second time to indicate where the money resulting from the sale of his donated assets should go. Initially the money will go into one of the donor advised organization's “finds” and eventually the money will pass out of the fund to the charity (106, 108) of the donor's choice.

8. Checks are sent from the DAO 104 to the designated charities (106, 108).

9. The donor 100 calculates the fair market value of the asset transfer for tax purposes. Determine the fair market value of the asset contributed as of the day of its transfer. Some organizations supply this information, but they are not required by law to do so. This may involve compiling information to fill out and IRS file tax form 8283, indicating which asset(s) was given to charity.

10. The donor 100 can repurchase the asset that was given away, or purchase a similar asset for investment purposes, as soon as the transfer is completed. This purchase is made with the cash that the donor 100 saved through giving an asset rather than cash. This step is used by the donor 100 to keep from “spending down” the value of their investment portfolio.

In an alternate scenario the donor 100 can donate assets directly to a receiving charity (106, 108), in which case steps 1, 7 and 8 described in FIG. 1 are not applicable.

This sequence, while not prohibitively difficult, is nevertheless certainly more complicated than merely writing checks to charity. The fact that the typical stock or mutual fund transfer takes 2-3 weeks also means that there is a certain risk involved during the transfer process that the value of the asset being given will drop from its price at the time the transfer process began. This risk is particularly great for more volatile stocks. Moreover, given the widespread procrastination of many donors who wait until the last few weeks of the year to calculate whether they have given all they wished to give to their charities, some late-year asset transfers may not be completed before the end of the year. This creates a problem for the donor, who typically wishes to receive a tax deduction in the current tax year.

Clearly, despite the tax advantages, there are a number of inconveniences to giving stock relative to the great convenience of writing a check. If the giving of appreciated securities is to become widespread beyond those who are wealthy, and become the preferred choice of giving to charity, another way must be found to simplify the entire transfer process.

### SUMMARY OF THE INVENTION

By helping individual donors more easily give appreciated assets to charity, and simultaneously encouraging them to increase their giving by the amount of their tax savings, the present invention stands to help increase the level of charitable contributions.

Beyond the immediate increase in giving resulting from increased giving efficiencies, non-profits also benefit from the fact that many individuals tend to be more generous when giving appreciated assets (which may have only cost them a small fraction of the asset's current value), and therefore any ability to facilitate gifts of stock and other appreciated assets stands to greatly benefit charity's revenue.

There are presently several new startups providing charitable giving via credit card over the internet, though no one is currently offering a way to give assets via the internet. Perhaps more importantly, virtually no DAO (including Fidelity's) currently offers a service to help the 25+ million households who give to charity each year in amounts under $10,000 (representing more than $70 billion per year). The present invention provides access to a DAO, for example GiveWell Foundation, for the transfer of appreciated assets to charity.

The present invention stands to revolutionize the current concept of how people think about giving to charity in America by creating the ability for everyone to give appreciated assets with the greatest of ease and simplicity by the click of a button. The present invention allows donors the option of setting up their giving of appreciated assets to be completely automated on a monthly or quarterly basis, so that they do not need to become involved in the details of the process. Thus, donors enjoy the full benefits of giving in the most tax-efficient way, without the hassles that currently exist.

The present invention provides: easy access to sophisticated evaluation tools for choosing gifts that maximize tax-efficient giving; fully automated transfer mechanism for giving appreciated assets on a continuing basis (e.g., monthly or quarterly); speed of transfer (instant transfer versus 1-3 weeks); “point, click and give” ease of transferring assets to charity; removal of wealth barriers in the area of asset gifting; back-office support for the transfer of assets to charities and donor advised organizations; and introduction of a unique ability to gift unrealized gains (while keeping 100% of the basis) through currently existing hedge funds.

The present invention provides the ability for anyone with online access to invested assets to give those assets to charity at the click of a button. Instead of taking 2-3 weeks from start to finish, the transfer process will occur on the same day, allowing the donor to know the actual time and value at which the gift is given, something not currently possible in the prior art. In fact, the present invention provides the donor with the ability to choose the price at which the asset is given to charity.

When a donor logs on to an investment company Web site to view investments, the donor can select a “Give to Charity” button that will allow the donor to give an appreciated asset to charity. Clicking the button will transport the donor to a Web site implementing an embodiment of the present invention, where the donor can request that his portfolio be analyzed. The donor can select which investments should be given to save the greatest amount in taxes (most investors do not track the cost basis of their investments, and therefore cannot easily make this calculation). The donor chooses the asset and how many shares should be given, along with which charity will receive the gift. The donor then clicks an “Execute Gift” button to send the asset to the charity.

The receiving charity does not actually receive the asset, but instead receives its cash value. The gifted asset is actually received by an intermediary charity. This intermediary charity is a qualified 501(c)(3) public charity and is able to issue tax receipts to the donor. The intermediary charity receives the asset the same day it is given and can immediately sell it. Then, a processing entity, acting on behalf of the intermediary, issues a check to the selected charity, minus any fees charged for the transaction process. A cover letter is attached to alert the charity to the donor's name and address (unless anonymity is requested), and to also state the purpose of the gift if stipulated by the donor. The donor may also stipulate that his charity of choice receive contributions from the intermediary charity at some future date (e.g., a set amount each month). By using the services of an intermediary charity and processing entity the charities can defer all asset transfers, rather than handling them themselves, allowing an intermediary charity to become their “back office” for asset transfers.

The present invention can also be used by the more than 550 donor advised-directed organizations (DAO) in America which are set up to help individuals make their charitable gifts with appreciated assets. These DAOs, sometimes referred to as Donor Advised Funds or Community Foundations, can be greatly benefitted through use of the present invention. Many DAO donors are currently giving appreciated assets (once the assets received by the DAO are sold, the donor may direct the money to other charities). The DAOs would benefit by the facilitation of asset selection and asset transfer for their current donors, and as an attraction to draw in new donors.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a flowchart of a prior art process for donating assets.

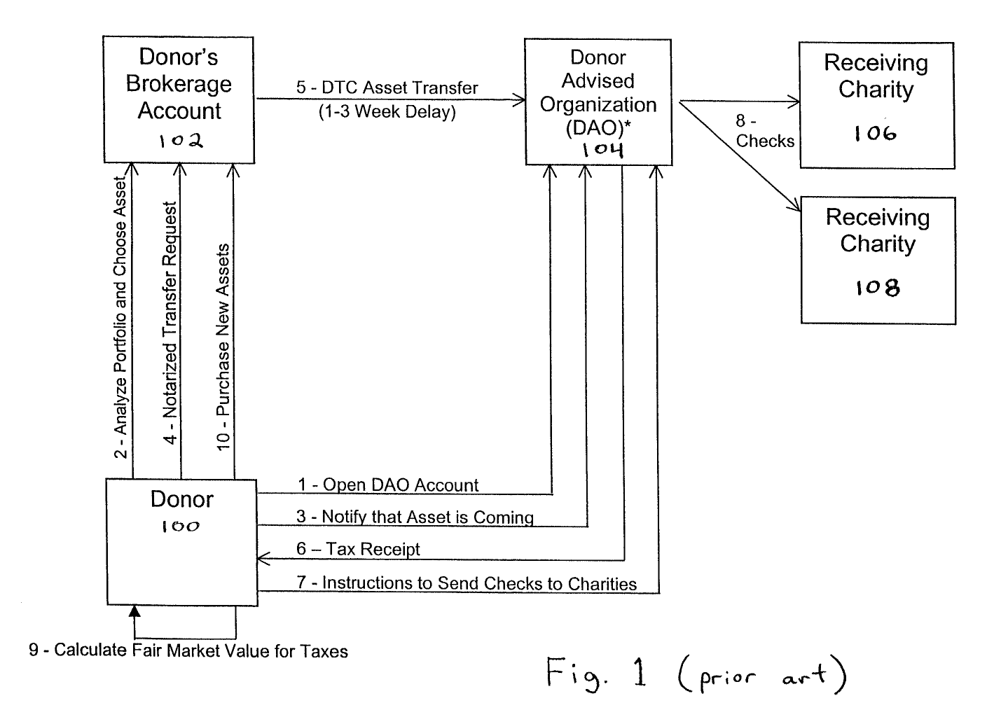

FIG. 2 is a diagram showing an automated system for the donation of appreciated assets as configured according to a preferred embodiment of the present invention.

FIG. 3 is a diagram showing a process for the donation of appreciated assets as configured according to an embodiment of the present invention.

FIG. 4 illustrates a computer system on which an embodiment of the present invention is implemented.

FIG. 5 shows the internal structure of a computer, as illustrated in FIG. 4.

### DETAILED DESCRIPTION OF THE INVENTION

A description of preferred embodiments of the invention follows.

The present invention facilitates the transfer of assets from a brokerage firm or mutual fund company to an intermediary charitable gift fund, a 501(c)(3) organization established to receive the donated assets. The intermediary will then automatically sell the assets and redirect the cash proceeds according to the instructions of the donor. The proceeds could go either to a donor advised organization (DAO), if the donor has established an account at the DAO, or to the charity itself (the intermediary charitable gift fund can function in the role of a DAO for those donors who have not chosen a DAO on their own). The following example illustrates the entire process where a donor has chosen to completely automate giving to charity via appreciated assets:

The donor requests a transfer of:

$500 each month from his checking account to his mutual fund account;

$200 each month from his mutual fund account to an intermediary account;

$100 each month from his intermediary account to his local house of worship;

$50 per month to a shelter for battered women;

$50 each month to the Audubon Society.

The donor doesn't have to worry about which shares of his mutual fund(s) should be given to charity, the gift analysis process will automatically make the most tax-efficient transfer on the donor's behalf, based on the information it knows about the donor. To optimize the tax efficiency of each transfer even further, the donor may elect to provide the system with additional information such as the following:

annual income;

primary state of residence;

whether the donor expects to itemize his tax deductions this year;

typical level of giving each year.

The present invention uses this information along with the details of his mutual fund purchases and transfers exactly $200 worth of mutual fund shares to his intermediary account and sends him a tax-deductible receipt thanking him for his contribution. The intermediary then automatically mails to the selected charities the checks the donor has requested be sent, and instructs the charities to send an acknowledgment letter (not a receipt) to the donor. On the same day the mutual fund shares are transferred, the $500 cash that has been received from the donor's checking account is used to repurchase the very same mutual fund the process just transferred out from. This allows the donor to instantly replace the $200 of mutual fund shares just given away with new shares having a higher cost basis. The repurchase process has no market risk because the donor is guaranteed to pay the same price for the repurchased shares as received credit for having given to the charity. The net increase in investments will be $300 ($500 purchased minus the $200 donated). Note that if the donor owns two different mutual funds in the account and has specified that the system keep 50% of the money in each fund at all times, instructions can be given to the system to send repurchase instructions to the mutual fund company to accomplish this goal. For example, the shares donated may be from one fund, while the shares that are simultaneously purchased may be a different fund. This helps the donor not only give in the most tax-efficient way, but also to maintain his desired portfolio allocation.

Some donors will want to have a certain degree of control over the assets they give to charity, but will still want to make use of the analysis/evaluation tools of the present inventions. In this example a donor purchases both mutual funds and individual stocks in a brokerage account. The intent is to give away a stock purchased two years ago that has gained 80% in value. However, the donor would like a second opinion regarding his choice. While connected to a Web site implementing and embodiment of the present invention, the donor clicks a “Help Me Choose” button to have the system's tax evaluation software analyze his portfolio. The system reports that the donor should consider giving Merrill Lynch Capital Class A mutual fund shares instead of his stock. The reason provided is that even though the mutual fund shares have a smaller gain (e.g., 65% versus the 80% gain in his stock), the mutual fund is expected to distribute a relatively large capital gain (e.g., $1.75/share) within the next two weeks. The analysis suggests that as long as the donor mind holding the stock longer, he is better off giving the mutual fund shares to avoid the forced capital gains distribution (on which taxes must be paid, even though none of the mutual fund shares were sold).

The system further makes suggestions regarding the repurchase of donated assets. For example, the system can recommend that the transfer be made on the day before capital gains distribution of the mutual fund, then suggest repurchasing the shares on the day following the distribution. If the donor agrees with the suggestion the system schedules the transfer and subsequent repurchase to take place on the recommended days. By considering information that was not immediately available to him, the donor is able to give away an asset (the mutual find) that was about to have a “forced” partial redemption, in the form of a capital gains distribution. Given that the majority of this distribution would have been short-term gain, the gift analysis system identified that giving the mutual fund shares was almost the same as giving the stock in regard to taxable consequences. However, by giving the mutual fund, the donor was not required to pay any taxes on the forced capital gains distribution.

Since some investors want complete control over which assets they keep, and which they give, the system provides a basic service that simplifies the ability to give assets to charity at any chosen time. For example, if a donor purchased 100 shares of XYZ Corporation stock eight months ago for a price of $10/share, it is worth $110/share today. The donor may be afraid the stock will lose significant value before being held long enough to qualify for long-term capital gains, so the donor may decide to sell the stock. However, the donor would like to give $3,000 of the proceeds to a local church. The donor has never given appreciated assets before and has always heard that only long-term gains should be given to charity. The present invention can show the donor that it is actually advantageous to give the XYZ Corporation stock, even though it is a short-term gain, based upon the fact that the system can track the fact that this donor does not itemizes deductions on their tax return.

The system calculates that she can save over $1,100 in state and federal taxes by giving part of the XYZ Corporation stock to charity. Convinced of the clear advantage of giving stock over giving cash, the donor fills out a short online application form and establishes an account with the intermediary charitable foundation.

In order to give the stock, the user logs on to her online brokerage account, clicks the “Give to Charity” button, and then selects the desired asset, in this case the XYZ Corporation stock. The donor types in “$3,000” when asked how much to give, and then clicks the “Give Now” button. The system calculates the number of shares needed to be transferred to equal approximately $3,000 and asks for confirmation. When the donor clicks “Yes,” the stock is immediately transferred to the intermediary charitable foundation and sold at the current price (e.g., $110.25/share). The cash proceeds are then deposited to the donor's intermediary charity account.

Once transferred, the donor can click on the “Request Gift for Charity” link. This will take the donor to the intermediary charitable foundation's Web site instructions for issuing checks to specific charities can be make (e.g., that a check in the amount of $250 per month be sent to a local church on the donor's behalf for the next twelve months, the gift totaling $3,000).

The intermediary charitable foundation sends a receipt acknowledging the gift, and at the end of the year also sends tax form 8283 to show that the donor gave appreciated stock to charity (which in this donor's case, will not need, since the donor she never itemizes deductions on their tax return). Even though the donor may have given about $3,000 to a local church every year, the donor has never received a tax benefit for that gift until now, because the donor has always taken the standard deduction on her tax return. But this time the donor was able to save over $1,100 in taxes (a tax savings of 36%) because the present invention provides a quick and simple way to give part of their appreciated stock shares before selling them.

In another embodiment of the present invention the donor is allowed to specify the conditions under which the asset is given. For example, the donor may wish to control the price at which the stock is given, or the day on which it is given.

For example, assume the donor owns 500 shares of XYZ Corporation which were purchased at $12.50/share. The price of XYZ Corporation is currently $21/share. The donor believes the stock is fully valued at $25/share and wishes to give it at that price. However, the donor also would like to get rid of the stock if the price begins falling. The donor connects to the system via an online broker and chooses an advanced “Give Stock” option, specifying that 500 shares of XYZ Corporation are to be given at a limit price of $25/share. Additionally, the donor specifies a “stop loss” to have the gift immediately executed if it falls below $18/share. The donor then requests that as soon as the gift is made, one-half of the proceeds are to be sent to the American Cancer Society to be used for their new endowment campaign.

Four weeks later the stock moves briefly above $25/share on a volatile day of trading, before falling back to the low twenties. As soon as the share price hits $25, the gift is made. The intermediary charity foundation receives the asset and sells it immediately, receiving $25/share minus the broker's commission for the trade. The donor receives a notice (e.g., via e-mail) indicating that the gift has been made. Another letter is mailed to the donor from the intermediary charity foundation for tax receipt purposes showing that 500 shares of XYZ Corporation were given at a price of $25/share. As soon as the trade settles, the intermediary charity foundation electronically transfers one-half of the cash proceeds from the sale to the American Cancer Society, one of its charity partners. An e-mail letter can also be sent to the head of the charity's development department to explain who has made the gift, and that it is to be used for the endowment campaign. The American Cancer Society sends a letter to the donor, thanking them for their generous contribution.

The benefits of the present invention accrue to multiple groups, including individuals, financial institutions, donor advised organizations and charities. Some of these benefits are summarized below:

Individuals:

increased convenience in giving appreciated assets;

more informed decisions regarding the best asset to give to charity;

automate process of giving to charity; and

increase tax savings resulting from gifts of appreciated assets.

Financial Institutions:

increase commissions by increasing number of trades as assets are given, sold by the receiving DAO, and repurchased by the donor;

increase asset base as donors begin to buy stocks for purpose of future giving;

retain a portion of gifted assets when the Intermediary charitable foundation invests assets at the investment firm;

encourage trading in bear markets as donors continue to give assets in lieu of cash; and

reduce transfer costs by automating the transfer process.

Donor Advised Organizations:

improve service to donors by simplifying asset gifting process;

simplify back-office paperwork by allowing the system to handle all asset transfers;

free-up staff to connect donors with opportunities for charitable giving in their community; and

grow donor base by providing a quick and easy means of giving assets to charity.

Charities:

provide back-office solution for receiving gifts of assets;

receive cash instead of assets by having the intermediary charitable foundation sell assets and send cash proceeds;

increase contribution levels by encouraging more generous giving via appreciated assets;

increase contributions by providing donors with monthly/quarterly automated giving; and

reduce fluctuations in monthly revenue by making automated monthly giving of appreciated assets easy.

These benefits are achieved through various embodiments of the present invention.

In one embodiment a data-processing business method of analyzing investor/donor portfolios to identify and select optimal tax efficient gifts to charity. A core part of the method assists donors in picking the best asset to give to charity. This will generally be the asset that provides the greatest tax savings when given. Forrester research suggests that as many as 85% of investors fail to adequately track the cost basis of their investment purchases, meaning that when it comes time to make gifts to charity, most individuals are not able to make the best choices regarding which assets should be given to charity. The present invention assists donors in this process, calculating and displaying tax implications of transferring specific assets to charity.

The method provides the steps to:

compile asset data from donor's multiple brokerage accounts (if more than one) onto a screen;

calculate and display unrealized gain of each asset owned by donor;

calculate estimated tax savings that could be achieved by giving each asset considering many variables that can create a taxable impact and be used as an input for the calculation, including (but not limited to): holding period of asset, commissions/loads, estimated repurchase cost of asset (as compared to the cash value received when the gifted asset is sold by the charity, at a minimum, this may represent the difference between the bid and the ask price for the asset), level of unrealized gain or loss for the asset, target asset allocation for donor's portfolio, distribution amount, type, and date (for mutual fund shares), non-profit status of the organization or entity ultimately to receive the proceeds (e.g., a Private Foundation, a 501(c)(3), a church, etc.), transfer cost of asset, adjusted gross income of donor, primary state of donor's residence, donor tax rates for federal, state, and local taxes, donor's choice of itemized or standard deduction on tax return, typical amount donor gives each year to charity;

report to donor the estimated tax savings available to the donor in giving each of the assets;

compare the estimated tax savings from donating the asset with the estimated tax savings were cash given instead of the asset, and show the increased tax savings resulting from giving the appreciated assets;

report to donor the estimated dollar and percentage increase in giving that can be achieved by giving the appreciated asset(s) instead of cash;

recommend the optimal selection of assets to gift to charity based on the calculated maximum tax savings which can be achieved;

encourage donor to give part or all of the estimated tax savings to charity;

allow donor to sort the results of calculations (e.g., sort by tax savings);

allow donor ability to view results in various groupings, such as by individual lots (where each lot represents a separate purchase of an asset), in aggregate by asset (multiple lots of the same asset purchased on different days or at different prices) or by long-term or short-term gain;

provide easy way for donor to select assets to be given to charity;

provide options for donor to specify only the dollar amount to be given to charity and require a method to select all asset lots for giving such that the current dollar value of the lots is equal to the amount specified by the donor;

if the asset provides a tax savings that is below a certain threshold (as set by the donor), automatically transfer cash from the donor's investment account to charity instead of transferring the asset (e.g., the donor may only want to make gifts that provide an average tax savings greater than 10% of the value of the asset).

In another embodiment of the present invention a business method of accelerated and controlled giving of assets to charity via the Internet is provided by locking in the dollar value a charity receives by offering the ability to lock in the dollar value a charity will receive when appreciated assets are contributed, whether the asset is immediately delivered to charity or not. The multitude of ways of selling a stock can be applied to the gifting of stock. In other words, selling stock and gifting stock are exact analogies, and every way that can be conceived to sell a stock (in the present or in the future) may be used to gift a stock. The selling techniques include:

“Market order” gifting of assets. The most common way for a donor to sell an asset is via “market order,” where the donor specifies a wish to receive the current market price for the asset the donor wants to sell. The present invention offers an analogous method for donors who wish to give their asset(s) to charity “at the market.” Currently the donor, when making a contribution, has little to no control over what price (or even what day) the transfer to charity will occur. Furthermore, once the charity receives the asset, the donor has no control over what price (or again, what day) the charity sells the asset it receives. With the market order gift method of the present invention, the donor may choose the exact instant at which an asset is transferred to charity and sold, thereby guaranteeing that the charitable contribution is made at a known price.

“Limit order” gifting of assets. Within the investment industry the concept of “limit orders” for stock purchases and sales is well established. The present invention introduces the same concept to the idea of gifting stock. Donors can establish the value at which they wish the stock to be transferred to charity, and when the price of the stock reaches that limit price, the transfer instructions are executed.

“Short stock, sell a call option or purchase a put option”. All three of these orders, when executed by the charity, allow the charity to “freeze” the minimum value of the asset that is being given by the donor. The donor may then transfer the asset at any time in the future. When the donor transfers the asset to the charity, it can be used to close out the short position, or be used for delivery to the purchaser of the call option, or the seller of the put option.

“Stop orders, stop limits and stop losses”. In the investment industry, the term “stop” refers to a value below the current price at which an investor holding a long position in a stock would sell immediately. One can place either a “stop loss” order, which triggers a sale at the very next market price, or a “stop limit” order, which only executes if the stock trades exactly at that price. For a donor wishing to gift an appreciated asset, he may enter a “stop” order for his gift that will cause the gift to be executed as soon as the value of the asset decreases to a certain price threshold (set by the donor).

“Day” orders. A day order is an order that is in effect one day only, expiring at the end of the trading day if it is not executed (all market orders are automatically day orders). When a donor wishes to give an asset at a specified price (a limit order), the donor may choose whether the gift limit order cancels at the end of the day or remains for multiple days.

“Good till canceled” orders. A good till canceled (“GTC”) order is a limit order that remains in effect for multiple days until it either expires, is canceled, or is executed. Donors who want to gift stocks at a specified limit price may choose GTC to leave the gift order open until it is filled, canceled or expires. Unlike traditional GTC buy/sell orders that last for a preset 30-60 days, the present invention allows the donor to specify how many days the gift order should remain in effect.

“All or none”. An all or none order indicates the order must be filled in its entirety, or not at all. Unlike “fill or kill,” the “all or none” order will not automatically be canceled if the order is not immediately filled. If a complete gift transaction is not executed under the specified conditions (e.g., the specified price), it will remain open for the time limit the donor has specified.

“Fill or kill”. A “fill or kill” time limit marks an order so that if it is not executed immediately in its entirety, the order is canceled. This differs from “immediate or cancel” in that “fill or kill” means a gift order must be filled in its entirety or it's canceled.

“Immediate or Cancel”. An “immediate or cancel” time limit marks an order so that if it is not executed partially or in its entirety immediately, it is canceled. This differs from “fill or kill” in that “immediate or cancel” allows an order to be partially or entirely filled.

“Minimum quantity”. Choosing “minimum quantity” allows a donor to require that a limit gift order be partially executed only if the number of shares to be given at the specified limit price meets or exceeds the value of the minimum quantity.

“Do not reduce”. Choosing “do not reduce” specifies that the donor does not want the limit or stop price reduced when the stock goes ex-dividend and the market price of the stock is reduced by the amount of the dividend. This condition may be placed on a limit order to give, a stop order to give, or on a stop limit order to give.

In conjunction with the asset selling techniques used, a reminder (e.g., electronic-mail) can be sent to donors when an asset hits a certain price. This is accomplished by placing the asset on a “watch-list” and monitoring the asset price using conventional price monitoring systems and comparing the current price to the donor specified price.

In yet another embodiment of the present invention a business method of accelerated and controlled giving of assets to charity via the Internet is provided by locking in the tax deduction the donor receives within a giving unit of time using the steps of:

implementing “time of day” receipting. When a gift order is executed (a market or limit gift order), a tax receipt will be generated that specifies the exact price of the stock at the instant the gift is made. The gift order can be considered to have been executed for tax purposes the instant at which the donor irrevocably makes a partnering charity, a company, or some other entity the transfer agent for processing the gift transfer. The value of the asset to be reported on the tax receipt will be calculated using either the average of the bid and the ask price for the asset at the time of the transfer, or will be equal to the value of the last trade completed before the gift was executed. An IRS ruling allowing that receipts to donors based on the time of day their contribution is received may affect the ability to issue “time of day” receipts;

allowing the donor to give an asset now and request that the charity sell the asset at a later date or a later price;

providing the donor with the choice of which method to follow in generating a tax receipt, including: 1) using the asset price at the time of the gift, 2) using the average of the asset's high and low for the day, or 3) allow the present invention to choose the best method for generating the tax receipt;

accelerating the transfer of assets given to charity. The process of instantaneously directing the transfer of assets from a donor to a charity using a global computer network, such as the Internet, is currently non-existent within the philanthropic industry. The present invention provide the means for any donor with an account at any financial services firm to give appreciated assets to any charity, all with “click and give” ease. Where integration with such a firm does not facilitate instantaneous transfers, the system will still accelerate the asset transfer more quickly than more traditional means provide. The following benefits are provided by the accelerated gift giving system. “Click 'n Give” donations of appreciated assets is provided. To give an asset online, the donor selects the asset while viewing his investment portfolio, or identifies the asset to be given by some other means, and the asset is quickly transferred to a recipient charity or other authorized account and converted into cash, which can then be sent to other charities of the donor's choosing. The processing of paperwork (faxes or mail) traditionally required to initiate an asset transfer from donor to charity may be removed in most cases. Transfer requests will be electronically submitted by the donor, a first for the charitable giving arena. Multiple lots of one or more assets can be instantly given to charity with just the click of a button.

In a further embodiment of the present invention a business method of immediately repurchasing an asset just after the asset is transferred to charity is provided using steps to:

select the asset to gift using the techniques of analyzing investor/donor portfolios to identify and select optimal tax efficient gifts to charity, as well as the accelerated and controlled giving of assets to charity techniques to execute the asset transfer to charity;

provide the ability for the donor to immediately repurchase the same or similar asset as soon as his gift is made to charity via instructions made with online software or via verbal instructions to a financial advisor using the software on the client's behalf The donor's investment firm will receive the instructions to repurchase the asset per the donor's request. The repurchase may be executed by cross matching the charity's sell order with the donor's repurchase (buy) order. This cross matching may be done to offer both the charity and the donor the best execution of their respective buy/sell order;

In yet another embodiment of the present invention a business method of automating the selection, gifting, and repurchase of assets given to charity is provided by completely automating the methods of 1) select the asset to gift using the techniques of analyzing investor/donor portfolios to identify and select optimal tax efficient gifts to charity, 2) accelerating and controlling giving of assets to charity techniques to execute the asset transfer to charity and 3) immediately repurchasing an asset just after the asset is transferred to charity. This automated process works for any asset transfer, but is especially well suited for gifts of mutual fund shares. The donor establishes certain parameters (e.g., the frequency of the gift transfers, amounts of each transfer, charities to receive the gifts, etc.) and the system uses the parameters to make decisions allowing for automated: selection of the asset to gift;

execution of the transfer to a partnering DAO or other qualified recipient;

sale of the asset within the receiving organization's account;

delivery of cash proceeds from the sale of the asset to the donor's recommended charities; and

repurchase in the donor's account of the same or similar asset that was transferred.

In another embodiment of the present invention a business method of (recommending) dispersing funds from a donor advised organization to charities is provided by steps to:

issue the donor charitable-gift checks or “ChariChecks” which can be used exactly like traditional checks for the purpose of giving to charity. The ChariChecks (charity checks) may only be used to pay 501(c)(3) organizations. The organizations eligible to receive these checks may or may not have been approved prior to the donor's writing of the check. The necessary funds for covering the checks would come from the donor's balance in a sub-account at an associated DAO. Writing a check that exceeded the balance of his sub-account would create a “bounced” check (i.e., “insufficient funds”) the same as if he had overdrawn his personal checking account at a local bank;

issue to the donor charity checks that work exactly like travelers checks. The checks would be issued in various size amounts (e.g., $50 per check) and could be used to give to any qualified 501(c)(3). Once the checks were issued to the donor, the donor's sub-account balance could be reduced by the amount of the checks;

give the donor a gift submission form that look exactly like a check. These forms can then be given to a charity. The charity can redeem the forms via phone or the Internet. There would be a unique number linking the form to the donor's charity account. The charity would be able to log onto the Internet (or dial a toll free number) and enter a) the amount of the gift, b) the unique identifying number on the submission form, and c) the donor's charity account number. The money would then be sent to the charity;

send pre-issued checks to the donor. The checks would be drawn from a bank account and would specify the name of the charity. The checks may or may not be pre-printed with a dollar amount to be given to the charity. If the dollar amount is specified on the checks, the value of the checks would be deducted from the donor's charity account when they are sent out to the donor. If the dollar amount is not pre-printed on the checks, then the check will only be able to be cashed by the charity if an adequate balance is available in the donor's charity account at the associated DAO (a service charge can be imposed on the donor for any “bounced” checks from an over-drawn account);

provide the donor with a charity debit card that may be used much like a credit card or a bank debit card. The card may be used to give to any 501(c)(3) organization;

provide a means for the donor to print checks for charitable gifts on his own printer while logged on to his Internet-based charity account.

Another embodiment of the present invention provides a business method for tax-efficient means for donors to give to charity via pre-tax payroll deduction, or other pre-tax means through the donor's employer by:

setting up a system whereby the employer structures a pay arrangement with the employee where the employer offer regular (e.g. monthly or quarterly) bonuses to the employee and the employer gives these bonuses to charity if the employee declines to receive the bonus. The employee has the right to accept each bonus, but also to decline it. The employer is not legally obligated to follow the recommendation of the employee on giving the gift to charity, but would be expected in general to accept the employee's instruction;

using flexible spending accounts (e.g., medical savings accounts) for charitable giving, have employees put in money into the flexible spending accounts and have the employee agree that at the end of the year, any money remaining in the accounts will be given to a donor advised organization. The money will be divided among all participating employees and placed into charity accounts for each employee. The employee may then use these funds to give to charity.

setting up pre-tax charity accounts with the employer on behalf of the employees. The money would be placed in these accounts periodically by the employer and made available to the employee to give to charity.

In another embodiment of the present invention a business method of tax-efficient hedge fund gifting is provided by hedge fund gifting of unrealized gains. One of the most powerful, yet least utilized, ways of giving tax-efficiently to charity involves hedge funds. As limited partnerships, hedge fund limited partners are able to temporarily withdraw their basis from their hedge fund, transfer part or all of the remaining unrealized gains to charity, and then return the withdrawn money (their basis) to the same or similar fund. The present invention provides the option for accredited investors who have the means to invest in hedge funds to gift unrealized gains to charity.

Another embodiment of the present invention provides a business method of making tax-efficient IRA pre-tax contributions to charities by facilitating the accelerated transfer of cash (or assets) from a donor's IRA or other qualified retirement plan to his charity account at a donor advised organization, or directly from his IRA to the charity of his choice. The donor/client specifies the portfolio mix for mutual funds in his IRA and the present invention can automatically sells the shares to maintain that mix. The cash is then immediately transferred to the donor's charity account.

Yet another embodiment of the present invention provides a business method of making tax-efficient gifts to charities by declining the receipt of distributions of mutual funds or other similar unitized funds. A donor/client establishes contractual relationship with a mutual fund company or a person or entity authorized to represent such a company. The contract gives the donor/client the ability to:

accept or decline any part or all of the shares of mutual funds representing dividends, short or long term capital gains, or any other optional or required distribution. The amount to be accepted or declined may be expressed in either percentage or dollar terms;

set a maximum or minimum dollar amount that may be accepted or declined;

specify whether the ability to accept or decline a distribution should be automatically executed or manually executed by the donor/client;

specify the duration of the contract in terms of either elapsed time or total dollars accepted or declined;

recommend a charity, donor-advised organization, or other person or entity that may receive the portion of the distribution that is declined;

authorize the repurchase of the number of shares or units that have been declined;

Where the mutual fund company manages participating mutual funds according to predetermined guidelines to generate a predictable percentage of distributions each year, calculated as a percentage of the dollar value of each mutual fund share price, or via some other such means. The mutual fund company establishes and adheres to a clear policy on how to evaluate donor/client's recommended disbursement of any declined distributions (e.g., by requiring the company's board to approve such disbursements).

In another embodiment of the present invention business methods for providing a stock processing service to non-profits, DAOs, private foundations, and other entities is provided. A contractual agency relationship is created with the destination organization (e.g., the non-profit) or entity (e.g., a CRT) that grants another proxy organization to receive a donor's stock and other gifts on behalf of the destination organization. The destination organization generally must be of the same legal structure as the proxy organization (e.g., both must be a public charity). This agency agreement will allow the proxy organization, on behalf of the destination organization, to do the following:

represent the destination organization to the donor without the donor's awareness of the proxy organization;

receive gifts such as stock and mutual funds from the donor with or without the donor's knowledge of the existence of the proxy organization;

issue tax receipts to the donor; and

send a “thank you” letter to the donor acknowledging receipt of the gift.

Additionally, a contract can be created with the destination organization to have a proxy organization receive funds on its behalf. The contract would allow the proxy organization, on behalf of the destination organization, to do the following:

guarantee that gifts given from the destination organization's donors will always be delivered to the destination organization. The donor may not be allowed to know of the existence of this guarantee if the proxy organization is a DAO; and

sell the assets donated and deliver the cash proceeds, minus any fees.

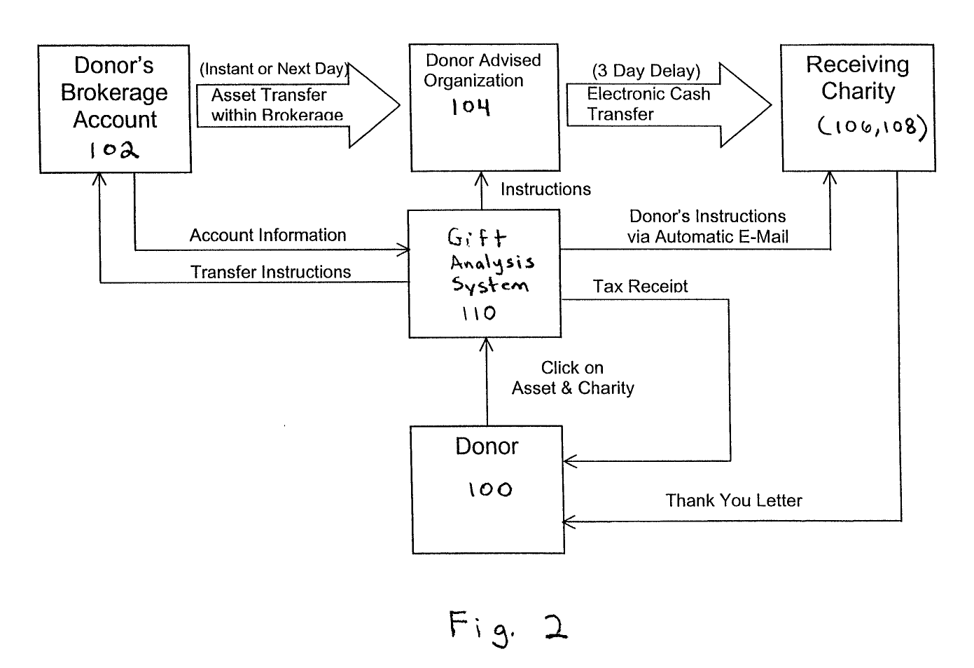

FIG. 2 is a diagram showing an automated system for the donation of appreciated assets as configured according to a preferred embodiment of the present invention. Donor 100 interfaces with gift analysis system 110 to initiate the process of transferring appreciated assets to a receiving charity (106, 108). The donor 100 may have come to interact with gift analysis system 110 by clicking a button at the receiving charity (106, 108) Web site, by logging on to the donor's brokerage Web site, or by visiting the Web site of Donor Advised Organization 104. A user interface to the gift analysis system 110 will be accessible from brokers, charities or other independent entry platforms (e.g., various Internet/Web portals).

The gift analysis system 110 receives asset account information from the donor's brokerage account 102. The gift analysis system 110 also receives personal information about the donor 100. The following table describes some of the numerous variables (gift analysis system data) that are evaluated in the present invention to provide optimized tax efficiency for donors. The default operation of the system will be to select the asset for gifting to charity that provides the greatest overall economic advantage to the donor.

The gift analysis system 110 will consider the following asset information in calculating the best assets to gift:

| Asset Information | Description |
|---|---|
| Holding period of asset | Long term - For donors who itemize their tax returns, the |
| | asset must have been held more than 365 days to qualify |
| | for a full deduction for tax purposes. |
| | Short term - Donors who do not itemize should consider |
| | giving appreciated assets that are short term since they are |
| | taxed at as ordinary income, which is a higher rate than |
| | long-term capital gains. |
| Commissions/Loads | Mutual Funds - The gain of a mutual fund that has a |
| | back-end load (fee) will be reduced by the value of the |
| | load. The cost of the load effectively will reduce the tax |
| | savings the system will deduct the cost of the load from |
| | the gain in reporting the net tax savings to the donor. If |
| | there is a commission to sell a mutual fund once the |
| | charity receives it, this will also reduce the gain of the |
| | mutual fund shares. |
| | Stocks - The commission cost to sell the stock once it is |
| | received by the charity reduces the appreciated gain on |
| | the stock. |
| Repurchase cost of asset | Mutual Funds - When giving mutual funds with loads |
| | (front end or back end), the cost of the load must be taken |
| | into account when calculating the optimal asset to give. If |
| | the investor is also required to pay a commission to |
| | repurchase the mutual fund, this must be factored in as |
| | well. |
| | Stocks - Gifts of stock require two considerations: 1) the |
| | commission repurchase cost of the asset (negligible for |
| | deep-discount brokers, but important for full-service |
| | brokerage firms), and 2) the typical spread for the stock (a |
| | factor for thinly traded stocks which have a large bid/ask |
| | spread). |
| Level of gain or loss | At certain times in the market (e.g., a bear market), an |
| | investor may have some assets with sizeable short-term or |
| | long-term losses. If the donor allows for it, the software |
| | can consider selling assets at a loss and then transferring |
| | the cash rather than an asset to charity. |
| Target asset allocation | An optional service to the investor will be to allow him to |
| | specify the asset allocation of his investment portfolio |
| | (e.g., 40% large cap, 30% small cap, and 30% |
| | international). When his actual allocation deviates from |
| | his desired allocation, the system can bias the assets it |
| | chooses for giving in such a way as to move the investor |
| | back in line with his desired allocation. |
| Distribution amount, | Capital gains - For mutual funds, end-of-year capital |
| type, and date | gains distributions can cause the investor to pay a sizeable |
| | amount in taxes, even though he has not sold his mutual |
| | fund. By considering the amount of the anticipated capital |
| | gain and the date of distribution, the system can seek to |
| | give assets that will be passing large capital gains on to its |
| | investors. |
| | Dividends - For mutual funds and stocks that distribute a |
| | quarterly dividend, the system can consider this |
| | information in choosing the asset to transfer. Ideally an |
| | asset would be transferred to charity just before it |
| | distributes a dividend to the investor (otherwise, receipt of |
| | the dividend becomes a taxable distribution to the |
| | investor). |
| | Interest - Individual bonds and mutual funds that have a |
| | high percentage of bonds in their portfolio make periodic |
| | distributions of interest. The value of the bond or mutual |
| | fund shares decreases by the amount of the interest |
| | distribution on the distribution date. Gifts of assets that |
| | make interest distributions should ideally be made before |
| | the next interest distribution. |
| Transfer cost | If either the brokerage firm or the DAO charges a fee for |
| | the donor to transfer the asset to charity, this amount must |
| | be factored in when calculating the overall savings of |
| | giving an asset to charity versus giving cash. |

The present invention will also use the personal information described below, if provided by the donor, to increase the ability of the gift analysis system 110 in achieving maximum tax efficiency in asset giving. The gift analysis system 110 will consider the following personal information in calculating the best assets to gift:

| Personal Information | Description |
|---|---|
| Adjusted gross income | The donor's total income determines his tax bracket, and |
| | therefore the level of savings available to him in giving |
| | stock to charity. Donors with an adjusted gross income in |
| | excess of $127,000 begin losing part of their charitable |
| | deductions through the alternative minimum tax (AMT). |
| Primary state of | State tax rates vary widely on capital gains (short and long |
| residence | term). Knowing the donor's state of residence allows the |
| | program to consider the state's tax impact of giving assets. |
| Itemized or standard | Given that 70% of all Americans who give to charity do not |
| deduction | itemize, it makes sense for many donors to consider gifting |
| | short-term gains rather than long-term gains. Short-term |
| | gains are taxed at a higher level than long-term gains on the |
| | federal level, and often on the state level as well. |
| Typical amount client | The level of a donor's annual giving is useful as a gauge for |
| gives each year to | determining how close he may be from itemizing his tax |
| charity (or plans to | return. If the donor is very close to reaching and exceeding |
| give this year) | his standard deduction, our software analysis tool may |
| | change its recommendation of which assets should be given |
| | (e.g., no assets with short-term gains would be given in |
| | such a case). |

The analysis tool will evaluate numerous variables in order to determine the optimal tax-efficient gift. The donor 100 can then send asset transfer instructions to the donor's brokerage account 102 such that the brokerage can initiate an asset transfer from the donor's brokerage account 102 to donor advised organization 104. A charity account with the brokerage can be used in lieu of donor advised account 104. Instructions regarding the timing of the asset transfer can also be sent by the donor 100, via gift analysis system 110, to affect the most tax-advantaged gift.

Additional instructions concerning which charity (106, 108) is to receive the gift are sent, via gift analysis system 110, to the donor advised organization 104 and the receiving charities (106, 108), in order that the proceeds of the sale of the transferred assets are sent to the proper receiving charities (106, 108).

The gift analysis system 110 generates a tax receipt, based upon the asset transfer, for the donor 100. Typically, the receiving charities (106, 108) will also send a “thank-you” letter to the donor.

The present invention provides donors with a simple, straightforward way to maximize their giving to charity by giving more tax efficiently. This process is extremely easy to use with minimal time required for the entire transfer process, eliminating one of the primary hindrances currently keeping individuals donating appreciated assets.

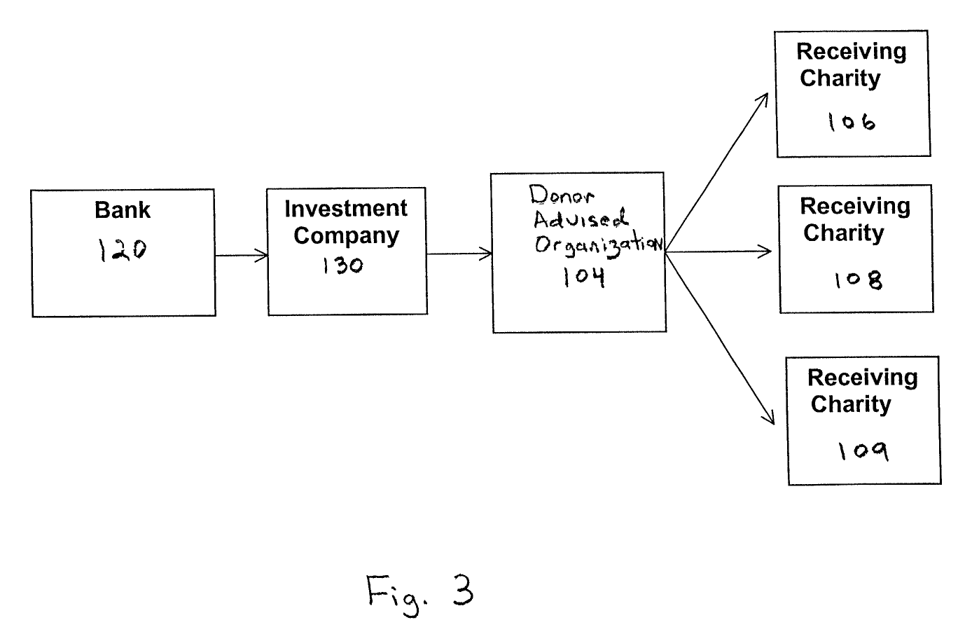

FIG. 3 is a diagram showing a process for the donation of appreciated assets as configured according to an embodiment of the present invention. An investor requests that his bank 120 send a fixed amount of money each month to his investment company 130 (e.g., his mutual fund company). The investment company 130 receives the cash and immediately invests it according to the previously specified investor's wishes. The investor makes a transfer of an appreciated asset from his investment account to a donor advised organization 104. This is done electronically by compiling donor assets, analyzing the assets and selecting specific assets to instruct the DAO 104 to transfer funds to. The DAO 104 then send checks out to the various charities on the donor's behalf. The funds can be transferred to the receiving charities (106, 108, 109) once the donor knows the exact value of the assets that have been transferred.

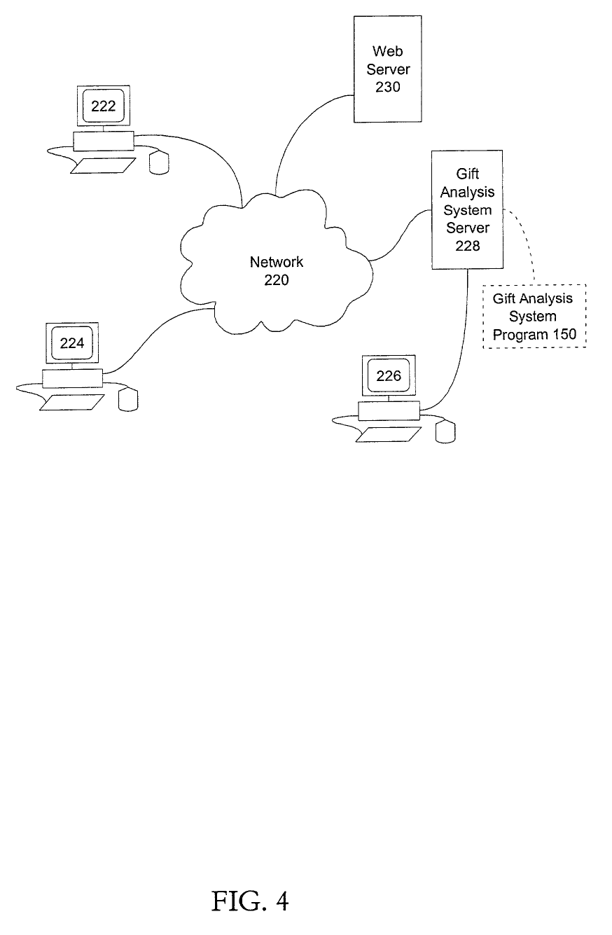

FIG. 4 illustrates a computer system on which an embodiment of the present invention is implemented. A gift analysis system server 228 provides analysis and processing for tax-advantaged asset transfer to charity via gift analysis system program 150. Gift analysis system server 228 is linked to other computers (222, 224, 226) on computer network 220 to provide access to donors, brokerages, banks, donor advised organizations, charities and any other entity needing access to the computer 100 is also linked to a network 110 having access to gift analysis system program 150. Web server 230 is also connected to network 220 and can host donor, brokerage, bank, donor advised organization, charity information. Gift analysis system program 150 can be stored on disk and loaded into memory to be executed by a processor on a variety of computers, including computers (222, 224, 226), gift analysis system server 228 and Web server 230.

Network 110 can be part of the Internet, the worldwide collection of computers, networks and gateways that use the TCP/IP suite of protocols to communicate with one another. The Internet provides a backbone of high-speed data communication lines between major nodes and host computers, consisting of thousands of commercial, government, educational, and other computer systems, that route data and messages.

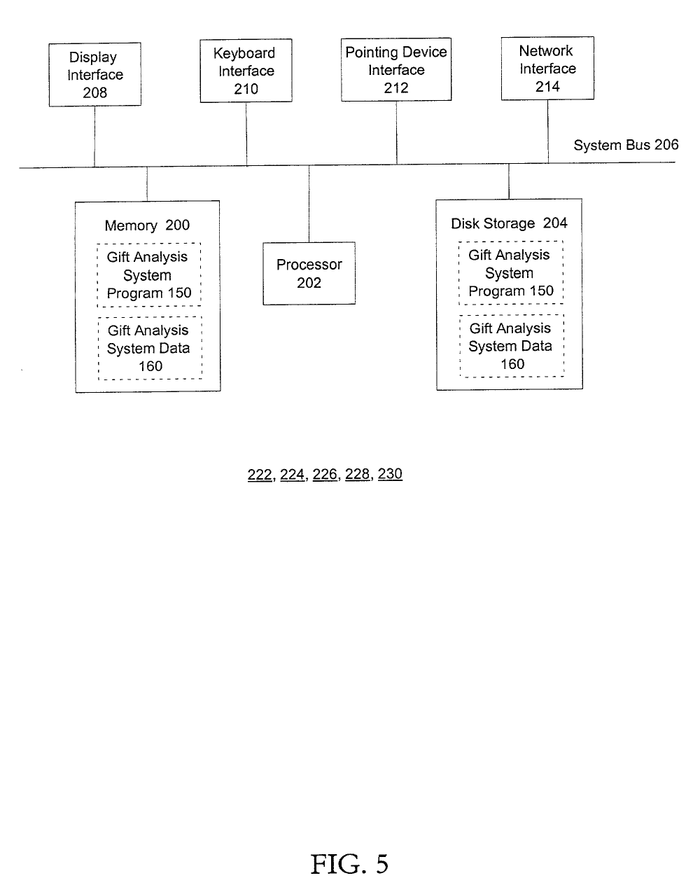

FIG. 5 shows the internal structure of a computer, as illustrated in FIG. 4 (e.g., For example computers (222, 224, 226), gift analysis system server 228 and Web server 230). Computers (222, 224, 226), gift analysis system server 228 and Web server 230 100 contain a system bus 206; a bus is a set of hardware lines used for data transfer among the components of a computer system. A bus is essentially a shared link that connects different parts of the system (e.g., processor, disk-drive controller, memory, and input/output ports) and enables the different parts to transfer information. Attached to system bus 206 is display interface 208, keyboard interface 210 and mouse interface 212 are also attached to system bus 206 and allow input devices to communicate with other components on system bus 206. Network interface 214 provides the link to an external network (e.g., network 220) allowing processes running on computers (222, 224, 226), gift analysis system server 228 and Web server 230 to communicate with the donor, brokerage, donor advised organization and charity. A memory 200 stores computer software instructions (e.g., gift analysis program 150) and data structures (e.g., gift analysis system data 160) used to implement an embodiment of the present invention (e.g., the gift analysis system 110). A processor 202 executes instructions stored in memory 200, allowing the computers (222, 224, 226), gift analysis system server 228 and Web server 230 to provide analysis and processing for tax-advantaged asset transfer to charity. A disk storage device 204 is provided for non-volatile storage on computers (222, 224, 226), gift analysis system server 228 and Web server 230.

While this invention has been particularly shown and described with references to preferred embodiments thereof, it will be understood by those skilled in the art that various changes in form and details may be made therein without departing from the scope of the invention encompassed by the appended claims.

A receiving entity as utilized by the present invention can be a donor advised organization, a donor directed organization, a non-profit organization, a foundation, a corporation, an individual or any similar entity or intermediary charitable organization. The most general assumption is that entity A will give to entity B, where A or B may be 1) individuals, 2) groups, 3) organizations, or 4) any other entity that has the ability to give or receive an asset.

An asset is merely any item that has either current or future value. The item may be tangible (e.g., a car, a painting, or a stock certificate) or it may be represented in electronic or symbolic form (e.g., shares of a mutual fund account reported on a Web site).

What is claimed is:

1. A computer based method for electronically analyzing a donor investment portfolio to identify assets representing tax efficient transfers from a donor to a receiving entity comprising the steps of:
compiling donor investment portfolio data from each brokerage account associated with the donor investment portfolio;
calculate and display unrealized gain of each asset in the donor investment portfolio;
calculate and display estimated tax savings achievable by transferring each asset in the donor investment portfolio to the receiving entity; and
selecting specific assets from the donor investment portfolio for transferring to the receiving entity.

2. The method of claim 1 wherein the receiving entity is a non-profit organization.

3. The method of claim 2 wherein the non-profit organization is a donor advised organization.

4. The method of claim 1 wherein the display is sorted by at least one of the calculated or displayed data items.

5. The method of claim 1 wherein the display is grouped by each calculated or displayed data item into groups representing: individual lots, aggregation by asset, long-term gain or short-term gain.

6. The method of claim 1 further comprising the steps of:
specifying a dollar amount to transfer to the receiving entity; and
selecting assets such that the current dollar value of the selected assets is substantially the same as the specified dollar amount to transfer.

7. The method of claim 1 further comprising:
electronically transferring cash to the receiving entity instead of assets in the donor investment portfolio if the assets in the donor investment portfolio provide an estimated tax savings that is below a predefined threshold.

8. The method of claim 1 further comprising the step of:
repurchasing a substantially similar asset immediately upon transferring the asset to the receiving entity.

9. The method of claim 8 wherein the repurchasing is accomplished by cross matching the repurchase of the substantially similar asset with the sale by the receiving entity of the asset.

10. The method of claim 1 wherein the selecting and transferring of the asset is completely automated by:
predefining parameters for the selection, transfer and repurchase of assets;
automatically selecting specific assets from the donor investment portfolio for transferring based upon the predefined parameters; and
electronically transferring the selected assets to the receiving entity.

11. The method of claim 10 further comprising the step of:
automatically repurchasing substantially similar assets immediately upon transferring the selected assets to the receiving entity.

12. The method of claim 10 wherein the parameters include at least one of: a frequency of transfer value, an amount of transfer value, an asset allocation, and an identification of charities to which to transfer assets.

13. The method of claim 1 wherein donor investment portfolio is maintained through a qualified retirement plan.

14. A computer based method for electronically controlling the price at which an asset is given in order to establish the tax receipt value for the donor in giving that asset and a dollar value that a receiving entity may receive in selling the asset comprising the steps of:
selecting an asset to transfer to the receiving entity;
selecting an asset transfer timing technique;
initiating a transfer of the asset to the receiving entity according to the selected asset transfer timing technique.

15. The method of claim 14 wherein the asset transfer timing technique is one of the following:
a market order at a specified date and time;
a limit order allowing the donor to establish the value at which the asset is transferred to the receiving entity;
a short, call option or put option allowing the receiving entity to fix the minimum value of the asset that is being transferred by the donor;
a stop, stop limit or stop loss order;
a day order;
a good-till-canceled order;
an all-or-none order;
a fill-or-kill order;
an immediate-or-cancel order;
a minimum-quantity order; and
a do-not-reduce order.

16. The method of claim 15 further comprising the step of:
enabling the receiving entity to immediately instruct a broker to sell the asset at substantially the same transfer timing price selected by the donor.

17. The method of claim 14 further comprising the step of:
creating a list of donor assets;
monitoring the list of donor assets; and
electronically sending an indication to the donor when the asset price of an asset on the list of assets reaches a predefined price.

18. A computer based method for instantaneously recording the tax deduction that a donor will receive for transferring an asset to a receiving entity comprising the steps of:
transferring the asset to the receiving entity; and
recording an exact price of the asset at the time the asset is transferred to the receiving entity.

19. The method of claim 18 wherein the exact price of the asset is calculated using the average of the bid price and ask price at the time the asset is transferred to the receiving entity.

20. The method of claim 18 wherein the exact price of the asset is calculated using the value of the last trade completed before the transfer was initiated.

21. The method of claim 18 further comprising the step of:
allowing the donor to specify the recommended time interval, or price, at which the asset is to be sold by the receiving entity after the transfer is complete.

22. The method of claim 18 wherein the tax deduction value is selectable using one of the following methods:
the asset price at the time of the transfer; or
the average of the asset's high price and the asset's low price for the day.

23. A computer based method of accelerating the transfer of an asset from a donor investment portfolio, to a receiving entity, by using a computer network, comprising the steps of:
compiling donor investment portfolio data;
selecting specific assets from the donor investment portfolio for transferring to the receiving entity; and
electronically transferring the selected assets to the receiving entity.

24. The method of claim 23 wherein a single or multiple assets may be selected and transferred using a single computer user interface action.

25. A computer based method for providing electronic asset processing services to a receiving entity comprising the steps of:
identifying a proxy organization having a relationship to the receiving entity allowing the proxy organization to receive an asset transfer on behalf of the receiving entity;
representing the proxy organization to the donor such that the donor may or may not be aware that the proxy organization is not the receiving entity;
receiving the asset transfer from the donor to the proxy organization;
transferring either the asset or cash proceeds from the sale of the asset from the proxy organization to the receiving entity; and
issuing to the donor a tax receipt for the asset transfer in the name of the receiving entity.

26. The method of claim 25 wherein the proxy organization guarantees that the received asset or the cash proceeds from the sale of the asset will always be transferred to the receiving entity.

27. A method for providing instructions from a donor to a donor advised organization regarding disbursement of funds held by the donor advised organization comprising the steps of:
establishing a donor account with the donor advised organization;
creating a charity check for use by the donor in requesting the donor advised organization to disburse funds from the donor account to a desired charity; and
issuing the charity check to the donor.

28. The method of claim 27 wherein the step of creating the charity check further comprises specifying a value of the charity check as a predefined amount.

29. The method of claim 27 wherein the step of creating the charity check further comprises:
specifying a value of the charity check;
specifying a unique identifier;
specifying the donor account number,
such that the charity check can be redeemed by supplying the value, unique identifier and donor account number over a communications medium.

30. The method of claim 27 wherein the charity check is created specifying a predefined charity.

31. The method of claim 27 wherein the charity check is created in the form of a financial debit card.

32. A method for providing tax-efficient transfers of employee compensation to a charity using an employer benefits system.

33. The method of claim 32 comprising the steps of:
establishing an agreement whereby the employer provides a bonus to the employee;
declining, in whole or in part, by the employee, the bonus offered to the employee;
recommending, by the employee, the charity to which the declined portion of the bonus is to be donated; and
transferring the bonus from the employer to the charity based upon evaluating the recommendation of the employee.

34. The method of claim 32 wherein monies paid into a pre-tax flexible spending account have a restriction that at the end of a specific financial period any remaining balance in the flexible spending account will be transferred to a predetermined receiving entity.

35. The method of claim 34 wherein the monies are periodically placed in pre-tax charity accounts by the employer and made available to the employee to give to charity.

36. A method for tax-efficient giving of units from a limited partnership, including a hedge fund, to a receiving entity comprising the steps of:
identifying the amount of unrealized gain allocated to the owner of the limited partnership units;
withdrawing all the money allocated to the owner of the limited partnership that is over and above the value of the unrealized gain; and
transferring at least a part of the remaining units that represent the owner's unrealized gain to the receiving entity.

37. The method of claim 36 wherein the owner uses at least a part of the money initially withdrawn from the limited partnership to purchase new units of the limited partnership.

38. A method for transferring a unitized fund's taxable distribution to a receiving entity comprising the steps of:
declining receipt, by the owner, of at least a portion of the unitized fund distribution;
specifying a receiving entity to receive the declined portion of the unitized fund distribution; and
delivering the declined portion of the unitized fund distribution to the receiving entity.

39. The method of claim 38 further comprising the step of:
repurchasing a number of units in the unitized fund substantially equal to the number of units declined in the unitized fund distribution.

40. The method of claim 38 wherein the unitized fund is managed according to a predetermined guideline to generate at a predictable percentage the unitized fund distribution each year.
